(19) United States
(12) Patent Application Publication
(10) Pub. No.: US 2007/0006980 A1
(43) Pub. Date: Jan. 11, 2007

(54) Roll up storm shutter slat connector retention system

(76) Inventors: Robert E. Zabala, Naples, FL (US); Mauro A. Zabala, Naples, FL (US)

Correspondence Address: EDWARD M. LIVINGSTON, PA, 963 TRAIL TERRACE DRIVE, NAPLES, FL, 34103, US

(21) Appl. No.: 11/178,108

(22) Filed: Jul. 8, 2005

(51) Int. Cl. E06B 9/08

(52) U.S. Cl. 160/133

(57) ABSTRACT

A roll up storm shutter slat connector (1) having a substantially rigid body, preferably made of extruded aluminum, having a hook end (3), a receiving end (4) and a centrally located channel (20) for the accommodation of a retention means (5). The slat connector (1) is compatible with conventional shutter slats (2) having a hook end (6) and a receiving end (7). In use, the present invention alternates between conventional shutter slats (2) to form a curtain (23). The retention means (5) located in the slat connectors (1) are inserted into retention tracks (8) and (21) wherein the slat connectors (1), and attached conventional shutter slats (2), are held in place during excessive forces.

### BACKGROUND OF THE INVENTION

This invention relates to roll up storm shutters, more particularly, a roll up storm shutter slat connection retention system that may be employed using conventional shutter slats currently on the market.

Hurricanes are known to reek havoc on societies. Hurricanes not only take lives, but leave a path of devastation in their wake wherein individuals are left feeling hopeless due to the structural damage to homes, businesses and communities. For example, Hurricane Andrew, which hit south Florida in 1992, killed 26 people and cost an estimated $26.5 billion dollars in damages. More recently, hurricanes Charley, Frances, Ivan and Jeanne, which hit the southeastern portion of the United States in 2004, killed a total of 152 people in the United States alone and are estimated to cost $41 billion dollars in damages. According to many meteorologists, above average hurricane activity is predicted for the Atlantic for approximately the next thirty years. Debates continue as to why the above average activity, but, nonetheless, individuals must be prepared for the worst possible scenario when dealing with deadly weather.

Currently, many individuals purchase hurricane storm shutters in order to protect one's family, friends and home. Typically these shutters include slats having a hooked end and a receiving end wherein the slats interlink together to form a curtain. Under current building codes, shutters must include large vertical supports located at predetermined distances on each side of the shutters to maintain the structural integrity of the shutters in high wind conditions. Otherwise, high winds will cause the shutter to blow inward, thereby pulling each side of the shutter from the retention tracks on each side, resulting in buckling or failure of the shutter system.

However, such large supports must be permanently installed and are not only visually unappealing, but they also necessitate a large amount of space, thereby reducing usable space on patios and lanais. In addition, it is very expensive to purchase and install shutters suing these large supports.

Thus, a need exists for a roll up storm shutter retention system that eliminates the necessity of vertical supports and still retains the shutter in side retention tracks in high wind conditions.

Some attempts have been made to fulfill the above need. Some shutter assemblies use slats wherein pins are located within each and every slat to reinforce the structural integrity of the curtains under excessive force. However, the use of such a large amount of pins causes the curtain to become very heavy and costly. Moreover, such systems require that special slats be manufactured to accommodate the pins, thereby making such systems unusable with conventional slats.

The relevant prior art includes the following references:

| Patent No. | | |
|---|---|---|
| (U.S. unless | | |
| stated otherwise) | Inventor | Issue/Publication Date |
| 4,723,588 | Ruppel | Feb. 09, 1988 |
| 6,006,815 | Schanz | Dec. 28, 1999 |
| 5,322,108 | Hoffman | Jun. 21, 1994 |
| 6,305,456 | Sanchez | Oct. 23, 2001 |
| D472,328 | Wenrick et al. | Mar. 25, 2003 |
| 2004/0003903 | Wenrick et al. | Jan. 08, 2004 |
| 6,095,225 | Miller | Aug. 01, 2000 |
| 4,690,193 | Morrison et al. | Sep. 01, 1987 |
| 5,515,902 | Hoffman | May 14, 1996 |
| 5,210,924 | Schneider | May 18, 1993 |
| 5,839,493 | Quasius | Nov. 24, 1998 |
| 6,631,749 | Zabala | Oct. 14, 2003 |

None of the above prior art discloses a shutter system like the present invention.

### SUMMARY OF THE INVENTION

The primary object of the present invention is to provide a roll up storm shutter slat connector retention system that withstands large amounts of excessive force.

A further object of the present invention is to provide a roll up storm shutter slat connector retention system that uses conventional shutter slats.

An even further object of the present invention is to provide a roll up storm shutter slat connector retention system that is lightweight.

Another object of the present invention is to provide a roll up storm shutter slat connector retention system that is cost-efficient.

An even further object of the present invention is to provide a roll up storm shutter slat connector retention system that does not require large independent support structures to meet applicable hurricane building codes.

The present invention fulfills the above and other objects by providing a roll up storm shutter slat connector retention system having a substantially rigid body having a top edge and bottom edge of equal length and first and second side edges, a hook end located along the body top edge and a receiving end located along the body bottom edge. The body hook end attaches to a receiving end of a conventional slat and the body receiving end attaches to a hook end of an adjacent conventional slat. The body has a substantially centrally located channel for a retention means on the first and second side edges.

The retention means is a retention pin attached on both ends of the slat connector. The retention pins are inserted into retention tracks located on either side of a portal opening, such as a window or doorway, to keep the roll up storm shutter slat connector retention system from buckling or fatiguing under high winds.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a front view of the shutter system of the present invention installed with conventional slats on a building;

FIG. 2 is a end view of the slat connector of the shutter system of the present invention;

FIG. 3 is a front plan view of the slat connector of the shutter system of the present invention;

FIG. 4 is a end view of the slat connectors of the shutter system of the present invention linked to a conventional shutter slat;

FIG. 5 is a one end view of a retention track of the shutter system of the present invention;

FIG. 6 is a top plan sectional view of a retention pin assembly of the shutter system of the present invention;

FIG. 7 is an end sectional view of the shutter assembly in the retention track in a disengaged position of the shutter system of the present invention;

FIG. 8 is an end sectional view of the shutter assembly of the present invention in the retention track in an engaged position of the shutter system of the present invention; and

FIG. 9 is an end view of the shutter system of the present invention in a roll up storage condition.

### DESCRIPTION OF THE PREFERRED EMBODIMENTS

For purposes of describing the preferred embodiment, the terminology used in reference to the numbered components in the drawings is as follows:

1. slat connector

2. conventional slat

3. hook end of interslat device

4. receiving end of interslat device

5. retention means

6. hook end of conventional slat

7. receiving end of conventional slat

8. first retention track

9. building exterior

10. window

11. window sill

12. retention pin guide area

13. retention pin head

14. retention pin

15. retention arm

16. support wall

17. side edge

18. first retention track wall

19. second retention track wall

20. retention pin channel

21. second retention track

22. curtain

23. roll-up cylinder

With reference to FIG. 1, a front view of the slat connector 1 of the present invention installed between conventional slats 2 on a building exterior 9 is shown. The slat connector 1 alternates with conventional slats 2 so as to form a curtain 22 for providing protection of windows 10, patios or other portal openings (such as doors) in severe weather. The ends of the slat connectors 1 and conventional slats 2 are retained in a pair of retention tracks, a first retention track 8 and a second retention track 21, which may be located along the length on each side of a window 10, preferably ending at a window sill 11. When in a closed position, the slat connectors 1 and conventional slats 2 cover the entire window 10.

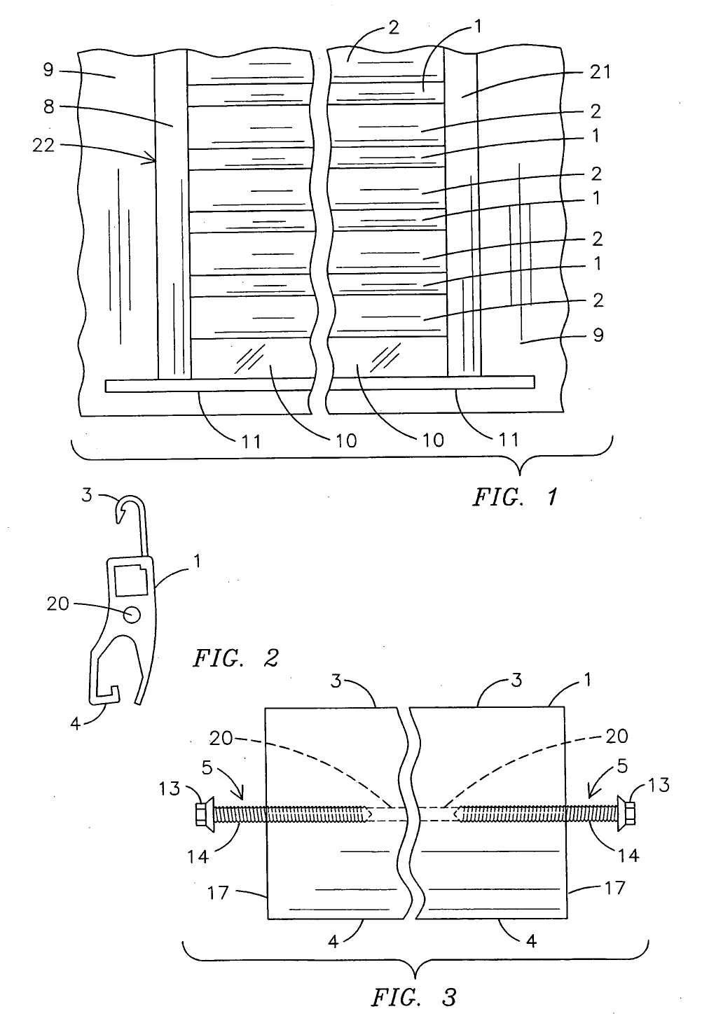

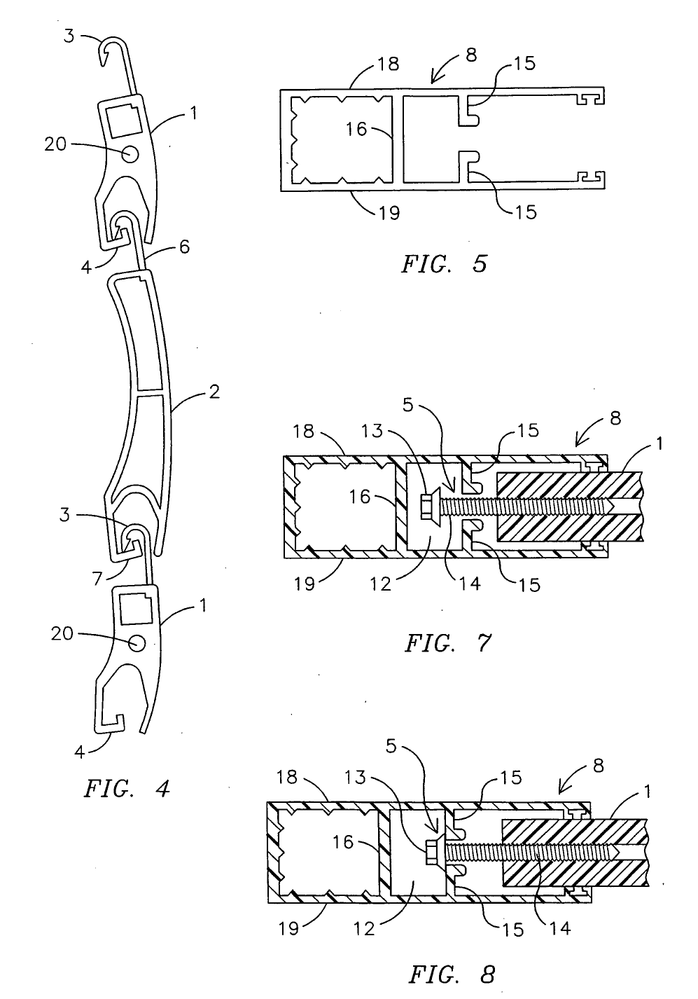

As shown in FIG. 2, the slat connector 1 has a substantially rigid body, which for weather resistance and lightweightness is preferably made of an extruded aluminum, having a hook end 3 on a top edge and a receiving end 4 on a bottom edge. As further illustrated in FIG. 4, the hook end 3 is designed so as to hook onto a receiving end of a conventional slat 2 whereas the receiving end 4 is designed so as to receive a hook end of a conventional slat 2. A retention pin channel 20 is located at a substantially central location in the slat connector 1.

As illustrated in FIG. 3, the slat connector 1 has a hooked end 3, a receiving end 4 and two side edges 17. A retention means 5, preferably a threaded pin 14, extends from each side edge 17 of the retention pin channel 20. The retention pin channel 20 is smaller in diameter than the threaded pin 14 so that when the threaded pin 14 is inserted into the hollow retention pin channel 20 the threaded pin 14 threads the retention pin channel 20. The slat connector 1 is constructed so as to withstand excessive forces without buckling or fatiguing. In use, the retention means 5 is located within a first and second track assembly 8 and 21.

FIG. 4 shows the slat connectors 1 attached to a conventional slat 2. Conventional slats 2 have hook ends 6 and receiving ends 7. To use the slat connector 1 of the present invention, a hook end of a conventional slat 6 is inserted into a receiving end of a slat connector 4 while a receiving end of a conventional slat 7 accommodates a hook end of another slat connector 3. The slat connector 1 is sturdy enough to withstand excessive forces, such as forces from hurricanes or other storms.

FIG. 5 illustrates the retention tracks of the present invention which are used in pairs, 8 and 21, on each side of a section of slats to guide the slats up and down a portal being covered by the slats. Each retention track has outer walls 18 and 19 attached in parallel to each other to guide the shutter assembly as it is unrolled to a closed position and rolled up to an open position. Preferably, each retention track has two retention arms 15 facing away from a support wall 16 located in the retention track 8, said retention arms 15 designed to retain the head 13 of the retention pin 14 in the tracks.

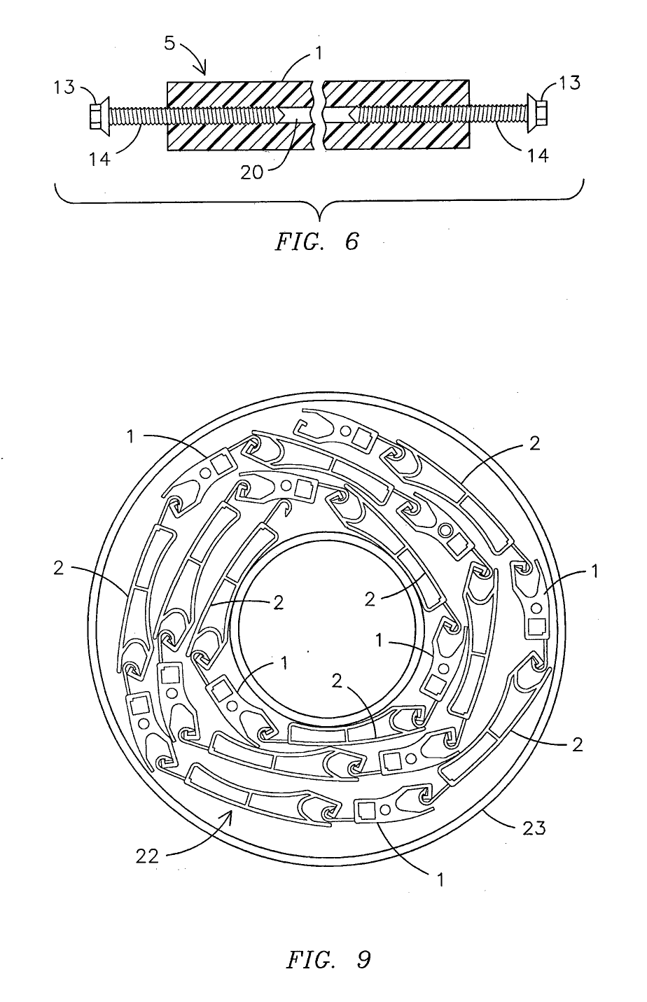

FIG. 6 shows a top plan sectional view of the retention means 5 of the slat connector 1. As illustrated, the retention means 5 is a threaded retention pin 14 having a pin head 13. Because the slat connector 1 is sturdy enough to withstand excessive forces, additional reinforcements which weigh down the assembly are not needed. However, a retention bar (not shown) may be used within the retention pin channel 20 and run along the entire length of the slat connector 1 so as to provide additional reinforcement.

FIGS. 7 and 8 show end views of the retention means 5 of the connector slats 1 inserted into a retention track 8, FIG. 7 showing a disengaged position when the shutter assembly is not experiencing high winds against it, and FIG. 8 when the shutter assembly is engaged against retention arms 15 as it would appear in high wind conditions to prevent buckling and fatigue of the shutter assembly. In a disengaged position, the pin head 13 of the retention pin 14 is located with a retention pin guide area 12 away from the retention arms 15. When in an engaged position, the pin head 13 is pressed inward against the retention arms 15 so as to retain the slat connector 1 and thereby the entire shutter assembly within the retention track 8 to prevent buckling and failure of the shutter assembly in high wind conditions.

Finally, FIG. 9 shows end view of the shutter system of the present invention in a rolled up storage condition in a roll-up cylinder 24 with the slat connector 1 interlocked with conventional slats 2.

As described and illustrated above, the slat retention connector of the present invention will eliminate the necessity of using vertical supports in hurricane shutter systems and allow conventional slats to be used while still retaining the shutters in side retention tracks during high wind conditions.

It is to be understood that while a preferred embodiment of the invention is illustrated, it is not to be limited to the specific form or arrangement of parts herein described and shown. It will be apparent to those skilled in the art that various changes may be made without departing from the scope of the invention and the invention is not be considered limited to what is shown and described in the specification and drawings.

Having thus described my invention, I claim:

1. A roll up storm shutter slat retention connector for use with at least two conventional shutter slats each having hook ends, receiving ends and two side edges, said roll up storm shutter slat retention connector comprising:
a substantially rigid body having a top edge and bottom edge;
said top edge having a predetermined length;
said bottom edge having a same predetermined length as said top edge length;
said substantially rigid body having a first and second side edges;
a hook end located along said top edge;
a receiving end located along said bottom edge;
wherein said hook end of the slat retention connector attaches to said conventional shutter slat receiving end on a first conventional slat;
wherein said receiving end of the slat retention connector attaches to said conventional shutter slat hook end on a second conventional slat;
said body of the slat retention connector having a substantially centrally located channel for holding a retention means on the first and second side edges; and
a retention means insertable within the channel of the slat retention connector.

2. A roll up storm shutter slat connector retention assembly comprising:
at least two conventional shutter slats each having hook ends, a top edge, a bottom edge and two side edges;
a slat retention connector having a substantially rigid body with a top edge and bottom edge, said top edge having a predetermined length, said bottom edge having a same predetermined length as said top edge length, said substantially rigid body having a first and second side edges, a hook end located along said body top edge, and a receiving end located along said body bottom edge, wherein said hook end of the slat retention connector attaches to said conventional slat receiving end on a first conventional slat and wherein said receiving end of the slat retention connector attaches to said conventional slat hook end on a second conventional slat, said body of said slat retention connector having a substantially centrally located channel for holding a retention means on the first and second side edges; and
a first retention track and a second retention track mounted on opposite sides of a portal opening covered by the shutter, said first retention track and second retention track having at least two parallel walls with at least one retention arm extending inwardly from each wall, wherein said first retention track and second retention track receives said retention means between said at least one retention arm extending inwardly from each wall.

3. The roll up storm shutter slat retention connector of claim 1 wherein:
said retention means is a pin.

4. The roll up storm shutter retention assembly of claim 2 wherein:
said retention means is a pin.

5. The roll up storm shutter slat retention connector of claim 3 wherein:
said retention means has a head and a body.

6. The roll up storm shutter retention assembly of claim 4 wherein:
said retention means has a head and a body.

7. The roll up storm shutter slat retention connector of claim 1 wherein:
said roll up storm shutter slat connector retention assembly is made of extruded aluminum.

8. The roll up storm shutter retention assembly of claim 2 wherein:
said roll up storm shutter slat connector retention assembly is made of extruded aluminum.

9. A roll up storm shutter retention assembly made of extruded aluminum comprising:
at least two conventional shutter slats each having hook ends, a top edge, a bottom edge and two side edges;
a slat retention connector having a substantially rigid body with a top edge and bottom edge, said top edge having a predetermined length, said bottom edge having a same predetermined length as said top edge length, said substantially rigid body having a first and second side edges, a hook end located along said body top edge, and a receiving end located along said body bottom edge, wherein said hook end of the slat retention connector attaches to said conventional slat receiving end on a first conventional slat and wherein said receiving end of the slat retention connector attaches to said conventional slat hook end on a second conventional slat, said body of said slat retention connector having a substantially centrally located channel for holding a pin on the first and second side edges, said pin having a head and a body; and
a first retention track and a second retention track mounted on opposite sides of a portal opening covered by the shutter, said first retention track and second retention track having at least two parallel walls with at least one retention arm extending inwardly from each wall, wherein said first retention track and second retention track receives said retention means between said at least one retention arm extending inwardly from each wall.

10. A method of assembling a roll up storm shutter slat retention connector for use with at least two conventional shutter slats each having hook ends, receiving ends and two side edges, said roll up storm shutter slat retention connector comprising a substantially rigid body having a top edge and bottom edge; said top edge having a predetermined length; said bottom edge having a same predetermined length as said top edge length; said substantially rigid body having a first and second side edges; a hook end located along said top edge; a receiving end located along said bottom edge; wherein said hook end of the slat retention connector attaches to said conventional shutter slat receiving end on a first conventional slat; wherein said receiving end of the slat retention connector attaches to said conventional shutter slat hook end on a second conventional slat; said body of the slat retention connector having a substantially centrally located channel for holding a retention means on the first and second side edges; and a retention means insertable within the channel of the slat retention connector, said method comprising the steps of:
a. connecting said body hook end to said conventional slat receiving end on a first conventional slat so said edges of said body align with said edges of said conventional slat;
b. connecting said body receiving end to said conventional slat hook end on a second conventional slat so said edges of said body align with said edges of said conventional slat; and
c. performing steps a and b so as to form a curtain of a predetermined length wherein a conventional slat alternates with a roll up storm shutter slat retention connector.

11. The method of claim 10 further comprising:
at least two conventional slats; and
a first retention track and a second retention track mounted on opposite sides of a portal opening covered by the shutter, said first retention track and second retention track having at least two parallel walls with at least one retention arm extending inwardly from each wall, wherein said first retention track and second retention track receives said retention means between said at least one retention arm extending inwardly from each wall, said method further comprising a step after step c of:
d. inserting said retention means between said at least one retention arm extending inwardly from each wall of said first retention and second retention tracks.
